(19) United States
(12) Patent Application Publication
(10) Pub. No.: US 2012/0065334 A1
(43) Pub. Date: Mar. 15, 2012

(54) POLYMERIC BLENDS FOR SLIT FILM APPLICATIONS AND METHODS OF MAKING THE SAME

(75) Inventors: Fengkui Li, Houston, TX (US); John Ashbaugh, Houston, TX (US); David Rauscher, Angleton, TX (US)

(73) Assignee: Fina Technology, Inc., Houston, TX (US)

(21) Appl. No.: 12/882,271

(22) Filed: Sep. 15, 2010

(51) Int. Cl. C08L 23/10; C08L 23/14; C08L 23/12

(52) U.S. Cl. 525/186

(57) ABSTRACT

Films and processes of forming the same are described herein. The processes generally include providing a propylene-based polymer; contacting the propylene-based polymer with polylactic acid in the presence of a modifier to form a polymeric blend, wherein the modifier is selected from epoxy-functionalized polyolefins, maleic anhydride modified polyolefins, ethylene-methacrylate copolymers, styrene-ethylene-butadiene-styrene (SIBS) polymers, and combinations thereof; forming the polymeric blend into a film; and monoaxially orienting the film.

### FIELD

Embodiments of the present invention generally relate to polymeric materials containing biodegradable components.

### BACKGROUND

Synthetic polymeric materials, particularly polypropylene resins, are widely used in the manufacturing of a variety of end-use articles ranging from medical devices to food containers. Many industries, such as the tape and packaging industries, utilize these polymers in various manufacturing processes to create a variety of finished articles including monoaxially-oriented polypropylene (MOPP) films.

While articles constructed from synthetic polymeric materials have widespread utility, one environmental drawback to their use is that these materials tend to degrade slowly, if at all, in a natural environment. In response to environmental concerns, interest in the production and utility of more readily biodegradable polymeric materials has been increasing. These biodegradable materials, also known as “green materials”, may undergo accelerated degradation in a natural environment. However, the utility of these biodegradable polymeric materials is often limited by their poor mechanical and/or physical properties. Thus, a need exists for biodegradable polymeric compositions having desirable physical and/or mechanical properties.

In particular, a need exists for biodegradable polymeric compositions that may be processed into slit films (tapes) having improved properties such as tenacity and stillness, thus providing an environmentally friendly alternative to synthetic polymeric materials.

### SUMMARY

Embodiments of the present invention include processes of forming monoaxially-oriented films. The processes generally include providing a propylene-based polymer; contacting the propylene-based polymer with polylactic acid in the presence of a modifier to form a polymeric blend, wherein the modifier is selected from epoxy-functionalized polyolefins, maleic anhydride modified polyolefins, ethylene-methacrylate copolymers, styrene-ethylene-butadiene-styrene (SEBS) polymers, and combinations thereof; forming the polymeric blend into a film; and monoaxially orienting the film.

One or more embodiments include the process of the preceding paragraph, wherein the propylene-based polymer is selected from polypropylene homopolymer, polypropylene based random copolymer and polypropylene impact copolymer.

One or more embodiments include the process of any preceding paragraph, wherein the contact includes melt blending the propylene-based polymer, the polylactic acid, and the modifier.

One or more embodiments include the process of any preceding paragraph, wherein the polylactic acid has a concentration of from about 0.1 wt. % to about 49 wt. % based on the weight of the polymeric blend.

One or more embodiments include the process of any preceding paragraph, wherein the modifier has a concentration of from about 0.0 wt. % to about 20 wt. % based on the weight of the polymeric blend.

One or more embodiments include the process of any preceding paragraph, wherein the modifier is glycidyl methacrylate grafted polypropylene.

One or more embodiments include the process of any preceding paragraph, wherein the modifier is polyethylene co-glycidyl methacrylate.

One or more embodiments include the process of any preceding paragraph, wherein the modifier is maleic anhydride grafted polypropylene.

One or more embodiments include the process of any preceding paragraph, wherein the modifier is ethylene-methyl acrylate copolymer.

One or more embodiments include the process of any preceding paragraph, wherein the modifier includes a styrene-ethylene-butadiene-styrene (SEBS) polymer.

One or more embodiments include the process of any preceding paragraph, wherein the monoaxially oriented film has a machine direction 1% secant modulus greater than about 250 kpsi.

One or more embodiments include the process of any preceding paragraph, wherein the monoaxially oriented film has a machine direction 1% secant modulus in a range from about 300 kpsi to about 500 kpsi.

One or more embodiments include the process of any preceding paragraph, wherein the monoaxially oriented film has a machine direction tensile strength at yield of greater than about 25 kpsi.

One or more embodiments include the process of any preceding paragraph, wherein the monoaxially oriented film has a machine direction tensile strength at yield in a range from about 30 kpsi to about 60 kpsi.

One or more embodiments include the process or any preceding paragraph, wherein the monoaxially oriented film has a gloss 45° of less than about 100.

Embodiments further include films including a melt blended mixture of a propylene-based polymer, a polylactic acid, and a modifier, wherein the modifier is selected from epoxy-functionalized polyolefins, maleic anhydride modified polyolefins, ethylene-methacrylate copolymers, styrene-ethylene-butadiene-styrene (SEBS) polymers, and combinations thereof.

One or more embodiments include the film of the preceding paragraph, wherein the propylene-based polymer is selected from polypropylene homopolymer, polypropylene based random copolymer, and polypropylene impact copolymer.

One or more embodiments include the film of any preceding paragraph, wherein the modifier is selected from glycidyl methacrylate grafted polypropylene, polyethylene co-glycidyl methacrylate, maleic anhydride grafted polypropylene, styrene-ethylene-butadiene-styrene (SEBS) polymers, and combinations thereof.

One or more embodiments include the process of any preceding paragraph, wherein the polylactic acid has a concentration of from about 0.1 wt. % to about 49 wt. % based on the weight of the melt blended mixture.

One or more embodiments include the process of any preceding paragraph, wherein the modifier has a concentration of from about 0.0 wt. % to about 20 wt. % based on the weight of the melt blended mixture.

One or more embodiments include the process of any preceding paragraph, wherein the film has a gloss 45° of less than about 100.

### BRIEF DESCRIPTION OF DRAWINGS

FIG. 1 is a schematic diagram of a slit film tape line.

FIG. 2 is a plot of machine-direction hot stretch yield strength measured by Bruckner Karo IV lab stretcher at 135° C. at different draw ratio.

FIGS. 3A and 3B are plots of machine-direction tensile strength at yield and 1% secant modulus for the mono-oriented films prepared at different draw ratios at 135° C.

FIGS. 4A and 4B are plots of machine-direction tensile strength at yield and 1% secant modulus for the mono-oriented films prepared at different draw ratios at 150° C.

FIGS. 5A and 5B is a plot of the surface gloss 45° for the mono-oriented films prepared at different draw ratios at 135° C. and 150° C. respectively.

FIGS. 6A and 6B are plots of machine-direction tensile strength at yield and 1% secant modulus for the mono-oriented PP-PLA co-extruded films prepared at different draw ratios at 150° C.

### DETAILED DESCRIPTION

A detailed description will now be provided. Each of the appended claims defines a separate invention, which for infringement purposes is recognized as including equivalents to the various elements or limitations specified in the claims. Depending on the context, all references below to the “invention” may in some cases refer to certain specific embodiments only. In other cases it will be recognized that references to the “invention” will refer to subject matter recited in one or more, but not necessarily all, of the claims. Each of the inventions will now be described in greater detail below, including specific embodiments, versions and examples, but the inventions are not limited to these embodiments, versions or examples, which are included to enable a person having ordinary skill in the art to make and use the inventions when the information in this patent is combined with available information and technology.

Various terms as used herein are shown below. To the extent a term used in a claim is not defined below, it should be given the broadest definition skilled persons in the pertinent art have given that term as reflected in printed publications and issued patents at the time of filing. Further, unless otherwise specified, all compounds described herein may be substituted or unsubstituted and the listing of compounds includes derivatives thereof.

Further, various ranges and/or numerical limitations may be expressly stated below. It should be recognized that unless stated otherwise, it is intended that endpoints arc to be interchangeable. Further, any ranges include iterative ranges of like magnitude falling within the expressly stated ranges or limitations.

Polymeric materials containing biodegradable components and methods of making and using the Same are described herein. The polymeric blend compositions are formed of an olefin based polymer, polylactic acid and a modifier. Polymeric co-extruded compositions containing biodegradable components formed of an olefin based polymer, polylactic acid and a tic layer are further described herein.

The “biodegradable” component of the polymeric compositions arc generally materials capable of at least partial breakdown. For example, the biodegradable components may he broken down by the action of living things.

Embodiments of the present invention provide polymeric compositions containing biodegradable components that may be processed into slit films (e.g., tapes) having improved mechanical and/or physical properties such as strength, tenacity, stiffness, and low gloss.

### Catalyst Systems

Catalyst systems useful for polymerizing olefin monomers include any suitable catalyst system. For example, the catalyst system may include chromium based catalyst systems, single site transition metal catalyst systems including metallocene catalyst systems, Ziegler-Natta catalyst systems or combinations thereof, for example. The catalysts may be activated for subsequent polymerization and may or may not be associated with a support material, for example. A brief discussion of such catalyst systems is included below, but is in no way intended to limit the scope of the invention to such catalysts.

For example, Ziegler-Natta catalyst systems are generally formed from the combination of a metal component (e.g., a catalyst) with one or more additional components, such as a catalyst support, a cocatalyst and/or one or more electron donors, for example.

Metallocene catalysts may be characterized generally as coordination compounds incorporating one or more cyclopentadienyl (Cp) groups (which may be substituted or unsubstituted, each substitution being the same or different) coordinated with a transition metal through π bonding. The substituent groups on Cp may be linear, branched or cyclic hydrocarbyl radicals, for example. The cyclic hydrocarbyl radicals may further form other contiguous ring structures, including indenyl, azulenyl and fluorenyl groups, for example. These contiguous ring structures may also be substituted or unsubstituted by hydrocarbyl radicals, such as C₁ to C₂₀ hydrocarbyl radicals, for example.

### Polymerization Processes

As indicated elsewhere herein, the catalyst systems are used to form olefin based polymer compositions (which may be interchangeably referred to herein as polyolefin polymers or polyolefins). Once the catalyst system is prepared, as described above and/or as known to one skilled in the art, a variety of processes may be carried out using that composition to form olefin based polymers. The equipment, process conditions, reactants, additives and other materials used in polymerization processes will vary in a given process, depending on the desired composition and properties of the polymer being formed. Such processes may include solution phase, gas phase, slurry phase, bulk phase, high pressure processes or combinations thereof, for example. (See, U.S. Pat. No. 5,525,678; U.S. Pat. No. 6,420,580; U.S. Pat. No. 6,380,328; U.S. Pat. No. 6,359,072; U.S. Pat. No. 6,346,586; U.S. Pat. No. 6,340,730; U.S. Pat. No. 6,339,134; U.S. Pat. No. 6,300,436; U.S. Pat. No. 6,274,684; U.S. Pat. No. 6,271.323; U.S. Pat. No. 6,248,845; U.S. Pat. No. 6,245,868; U.S. Pat. No. 6,245,705; U.S. Pat. No. 6,242,545; U.S. Pat. No. 6,211,105; U.S. Pat. No. 6,207,606; U.S. Pat. No. 6,180,735 and U.S. Pat. No. 6,147,173, which are incorporated by reference herein.)

In certain embodiments, the processes described above generally include polymerizing one or more olefin monomers to form the polyolefin polymers. The olefin monomers may include C₂ to C₃₀ olefin monomers, or C₂ to C₁₂ olefin monomers (e.g., ethylene, propylene, butene, pentene, 4-methyl-1-pentene, hexene, octene and decene), for example. It is further contemplated that the monomers may include olefinic unsaturated monomers, C₄ to C₁₈ diolefins, conjugated or nonconjugated dienes, polyenes, vinyl monomers and cyclic olefins, for example. Non-limiting examples of other monomers may include norbornene, norbornadiene, isobutylene, isoprene, vinylbenzycyclobutane, styrene, alkyl substituted styrene, ethylidene norbornene, dicvclopentadiene and cyclopentene, for example. The formed polymer may include homopolymers, copolymers or terpolymers, for example.

Examples of solution processes are described in U.S. Pat. No. 4,271,060, U.S. Pat. No. 5,001,205, U.S. Pat. No. 5,236,998 and U.S. Pat. No. 5,589,555, which are incorporated by reference herein.

One example of a gas phase polymerization process includes a continuous cycle system, wherein a cycling gas stream (otherwise known as a recycle stream or fluidizing medium) is heated in a reactor by heat of polymerization. The heat may be removed from the cycling gas stream in another part of the cycle by a cooling system external to the reactor. The cycling gas stream containing one or more monomers may be continuously cycled through a fluidized bed in the presence of a catalyst under reactive conditions. The cycling gas stream is generally withdrawn from the fluidized bed and recycled back into the reactor. Simultaneously, polymer product may be withdrawn from the reactor and fresh monomer may be added to replace the polymerized monomer. The reactor pressure in a gas phase process may vary from about 100 psig to about 500 psig, or from about 200 psig to about 400 psig or from about 250 psig to about 350 psig, for example. The reactor temperature in a gas phase process may vary from about 30° C. to about 120° C., or from about 60° C. to about 115° C., or from about 70° C. to about 110° C. or from about 70° C. to about 95° C., for example. (See, for example, U.S. Pat. No. 4,543,399; U.S. Pat. No. 4,588,790; U.S. Pat. No. 5,028,670; U.S. Pat. No. 5,317,036; U.S. Pat. No. 5,352.749; U.S. Pat. No. 5,405,922; U.S. Pat. No. 5,436,304; U.S. Pat. No. 5,456,471; U.S. Pat. No. 5,462,999; U.S. Pat. No. 5,616,661; U.S. Pat. No. 5,627,242; U.S. Pat. No. 5,665,818; U.S. Pat. No. 5,677,375 and U.S. Pat. No. 5,668,228, which are incorporated by reference herein.)

Slurry phase processes generally include forming a suspension of solid, particulate polymer in a liquid polymerization medium, to which monomers and optionally hydrogen, along with catalyst, are added. The suspension (which may include diluents) may be intermittently or continuously removed from the reactor where the volatile components can be separated from the polymer and recycled, optionally after a distillation, to the reactor. The liquefied diluent employed in the polymerization medium may include a C₃ to C₇ alkane (e.g., hexane or isobutane), for example. The medium employed is generally liquid under the conditions of polymerization and relatively inert. A bulk phase process is similar to that of a slurry process with the exception that the liquid medium is also the reactant (e.g., monomer) in a bulk phase process. However, a process may be a bulk process, a slurry process or a bulk slurry process, for example.

In a specific embodiment, a slurry process or a bulk process may be carried out continuously in one or more loop reactors. The catalyst, as slurry or as a dry free flowing powder, may be injected regularly to the reactor loop, which can itself be tilled with circulating slurry of growing polymer particles in a diluent, for example. Optionally, hydrogen (or other chain terminating agents for example) may be added to the process, such as for molecular weight control of the resultant polymer. The loop reactor may be maintained at a pressure of from about 27 bar to about 50 bar or from about 35 bar to about 45 bar and a temperature of from about 38° C. to about 121° C., for example. Reaction heat may be removed through the loop wall via any suitable method, such as via a double-jacketed pipe or heat exchanger, for example.

Alternatively, other types of polymerization processes may be used, such as stirred reactors in series, parallel or combinations thereof, for example. Upon removal from the reactor, the olefin based polymer may be passed to a polymer recovery system for further processing, such as addition of additives and/or extrusion, for example.

### Polymer Product

The polymeric materials containing biodegradable components include one or more polyolefins. The polyolefins (and blends thereof) formed via the processes described herein may include, but are not limited to, linear low density polyethylene, elastomers, elastomers, high density polyethylenes, low density polyethylenes, medium density polyethylenes, polypropylene and polypropylene copolymers, for example.

Unless otherwise designated herein, all testing methods are the current methods at the time of filing.

In one or more embodiments, the polyolefins include propylene based polymers. As used herein, the term “propylene based” is used interchangeably with the terms “propylene polymer” or “polypropylene” and,refers to a polymer having at least about 50 wt. %, or at least about 70 wt. %, or at least about 75 wt. %, or at least about 80 wt. %, or at least about 85 wt. % or at least about 90 wt. % polypropylene relative to the total weight of polymer, for example.

In one or more embodiments, the propylene based polymers may have a molecular weight distribution (Mₙ/M_{w}) of from about 1.0 to about 20, or from about 1.5 to about 15 or from about 2 to about 12, for example.

In one or more embodiments, the propylene based polymers may have a melting point (Tₘ) (as measured by differential scanning calorimetry) of at least about 150° C., or from about 150° C. to about 170° C., or from about 160° C. to about 170° C., for example.

In one or more embodiments, the propylene based polymers may have a melt flow rate (MFR) (as determined in accordance with ASTM D-1238 condition “L”) of from about 0.5 dg/min. to about 30 dg/min., or from about 1 dg/min. to about 15 dg/min., or from about 1.5 dg/min. to about 5 dg/min.

In one or more embodiments, the polyolefins include polypropylene homopolymers.

Unless otherwise specified, the term “polypropylene homopolymer” refers to propylene homopolymers, i.e., polypropylene, or those polyolefins composed primarily of propylene and amounts of other comonomers, wherein the amount of comonomer is insufficient to change the crystalline nature of the propylene polymer significantly.

In one or more embodiments, the polyolefins include polypropylene based random copolymers. Unless otherwise specified, the term “propylene based random copolymer” refers to those copolymers composed primarily of propylene and an amount of at least one comonomer, wherein the polymer includes at least about 0.5 wt. %, or at least about 0.8 wt. %, or at least about 2wt. %, or from about 0.5 wt. % to about 5.0 wt. %, or from about 0.6 wt. % to about 1.0 wt. % comonomer relative to the total weight of polymer, for example. The comonomers may be selected from C₂ to C₁₀ alkenes. For example, the comonomers may be selected from ethylene, propylene. 1-butene, 1-pentene, 1-hexene, 1-heptene, 1-octene, 1-nonene, 1-decene, 4-methyl-1-pentene and combinations thereof. In one specific embodiment, the comonomer includes ethylene. Further, the term “random copolymer” refers to a copolymer formed of macromolecules in which the probability of finding a given monomeric unit at any given site in the chain is independent of the nature of the adjacent units.

In one or more embodiments, the polyolefins include polypropylene impact copolymers. Unless otherwise specified, the term “polypropylene impact copolymer” refers to a semi-crystalline polypropylene or polypropylene copolymer matrix containing a heterophasic copolymer. The heterophasic copolymer includes ethylene and higher alpha-olefin polymer such as amorphous ethylene-propylene copolymer, for example.

The polymeric materials containing biodegradable components may include at least 30 wt. %, or from about 31 wt. % to about 99 wt. %, or from about 65 wt. % to about 95 wt. %. or from about 80 wt. % to about 90 wt. % polyolefin based on the total weight of the polymeric composition. for example.

One or more of the polyolefins are contacted with a polyester, such as polylactic acid (PLA), to form the polymeric materials containing biodegradable components (which may also be referred to herein as a blend or blended material). Such contact may occur by a variety of methods. For example, such contact may include blending of the olefin based polymer and the polylactic acid under conditions suitable for the formation of a blended material. Such blending may include dry blending, extrusion, mixing or combinations thereof, for example.

The polymeric materials containing biodegradable components further include polylactic acid or other polyester. The polylactic acid may include any polylactic acid capable of blending with an olefin based polymer. For example, the polylactic acid may be selected from poly-L-lactide poly-D-lactide (PDLA), poly-LD-lactide (PDLLA) and combinations thereof. The polylactic acid may be formed by known methods, such as dehydration condensation of lactic acid (see. U.S. Pat. No, 5,310,865, which is incorporated by reference herein) or synthesis of a cyclic lactide from lactic acid followed by ring opening polymerization of the cyclic lactide (see, U.S. Pat. No. 2,758,987, which is incorporated by reference herein), for example. Such processes may utilize catalysts for polylactic acid formation, such as tin compounds (e.g., tin octylate), titanium compounds (e.g., tetraisopropyl titanate), zirconium compounds (e.g., zirconium isopropoxide), antimony compounds (e.g., antimony trioxide) or combinations thereof, for example.

In one or more embodiments, the polylactic acid may have a density of from about 1.238 g/cc to about 1.265 g/cc, or from about 1.24 g/cc to about 1.26 g/cc or from about 1.245 g/cc to about 1.255 g/cc (as determined in accordance with ASTM D792).

In one or more embodiments, the polylactic acid may exhibit a melt index (210° C. 2.16 kg) of from about 5 g/10 min. to about 35 dg/min., or from about 10 dg/min. to about 30 dg/min. or from about 10 dg/min. to about 20 dg/min. (as determined in accordance with ASTM D1238).

In one or more embodiments, the polylactic acid may exhibit a crystalline melt temperature (Tₘ) of from about 150° C. to about 180° C., or from about 160° C. to about 175° C. or from about 160° C. to about 170° C. (as determined in accordance with ASTM D3418).

In one or more embodiments, the polylactic acid may exhibit a glass transition temperature of from about 45° C. to about 85° C., or from about 50° C. to about 80° C. or From about 55° C. to about 75° C. (as determined in accordance with ASTM D3417).

In one or more embodiments, the polylactic acid may exhibit a tensile yield strength of from about 4,000 psi to about 25,000 psi, or from about 5,000 psi to about 20,000 psi or from about 5,500 psi to about 20,000 psi (as determined in accordance with ASTM D638).

In one or more embodiments, the polylactic acid may exhibit a tensile elongation of from about 1.5% to about 10%, or from about 2% to about 8% or from about 3% to about 7% (as determined in accordance with ASTM D638).

In one or more embodiments, the polylactic acid may exhibit a flexural modulus of from about 250,000 psi to about 600,000 psi, or from about 300,000 psi to about 550,000 psi or from about 400,000 psi to about 500,000 psi (as determined in accordance with ASTM D790).

In one or more embodiments, the polylactic acid may exhibit a notched lzod impact of from about 0.1 ft-lb/in to about 0.8 ft-lb/in, or from about 0.2 ft-lb/in to about 0.7 ft-lb/in or from about 0.4 ft-lb/in to 0.6 about ft-lb/in (as determined in accordance with ASTM D256).

The polymeric materials containing biodegradable components may include from about 0.1 wt. % to about 49 wt. %, or from about 1 wt. % to about 30 wt. % or from about 5 wt. % to about 20 wt. % polylactic acid based on the total weight of the polymeric composition, for example.

In one or more embodiments, the polymeric materials containing biodegradable components further include a reactive modifier. As used herein, the term “reactive modifier” refers to polymeric additives that, when directly added to a molten blend of immiscible polymers (e.g., the polyolefin and the PLA), may chemically react with one or both of the blend components to increase adhesion and stabilize the blend. The reactive modifier may be incorporated into the polymeric composition via a variety of methods. For example. during melt blending the polyolelin and the polylactic acid may be contacted with one another in the presence of the reactive modifier.

The reactive modifier may include functional polymers capable of compatibilizing a blend of polyolefin and polylactic acid (PO/PLA blend). Suitable reactive modifiers include epoxy-functionalized polyolefins, maleic anhydride modified polyolefins, ethylene-methacrylate copolymers, styrene-ethylene-butadiene-styrene (SEBS) polymers, and combinations thereof, for example.

In one or more embodiments, the functional polymer is a graftable polyolefin selected from polypropylene, polyethylene, homopolymers thereof, copolymers thereof, and combinations thereof.

In one or more embodiments, the reactive modifier comprises an epoxy-functionalized polyolefin. Examples of epoxy-functionalized polyolefins suitable for use in this disclosure include without limitation epoxy-functionalized polypropylene such as glycidyl methacrylate grafted polypropylene (PP-g-GMA), epoxy-functionalized polyethylene such as polyethylene co-glycidyl methacrylate (PE-co-GMA), and combinations thereof. An example of an epoxy-functionalized polyethylene suitable for use in this disclosure includes LOTADER® GMA products (e.g., LOTADER® AX8840, which is a random copolymer of ethylene and glycidyl methacrylate (PE-co-GMA) containing 8% GMA, or LOTADER® AX8900 which is a random terpolymer of ethylene, methyl acrylate and glycidyl methacrylate containing 8% GMA) that are commercially available from Arkema.

In one or more embodiments, the reactive modifier comprises maleic anhydride modified polyolefin. Examples of maleic anhydride-functionalized polyolefins suitable for use in this disclosure include without limitation maleic anhydride grafted polypropylene (PP-g-MA), maleic anhydride grafted polyethylene (PE-g-MA), and combinations thereof. An example of maleic anhydride grafted polypropylene suitable for use in this disclosure includes commercially available POLYBOND® 3200, containing 1.0 wt. % maleic anhydride, from Chemtura.

The reactive modifiers may be prepared by any suitable method. For example, the reactive modifiers may be formed by a grafting reaction. The grafting reaction may occur in a molten state inside of an extruder, for example (e.g., “reactive extrusion”). Such grafting reaction may occur by feeding the feedstock sequentially along the extruder or the feedstock may be pre-mixed and then fed into the extruder, for example.

In one or more embodiments, the reactive modifiers are formed by grafting in the presence of an initiator, such as peroxide. Examples of initiators may include LUPERSOL® 101 and TRIGANOX®301, commercially available from Arkema, Inc., for example.

The initiator may be used in an amount of from about 0.01 wt. % to about 2 wt. % or from about 0.2 wt. % to about 0.8 wt. % or from about 0.3 wt. % to about 0.5 wt. % based on the total weight of the reactive modifier, for example.

In one embodiment, the grafting reaction of GMA onto PP may be conducted in a molten state inside an extruder such as for example a single extruder or a twin-screw extruder. Hereinafter, such process is referred to as reactive extrusion. A feedstock comprising PP, GMA, and initiator (i.e., peroxide) may be fed into an extruder reactor sequentially along the extruder, alternatively the feedstock (i.e., PP, GMA, and initiator) may be pre-mixed outside and fed into the extruder.

In an alternative embodiment, the PP-g-GMA is prepared by grafting GMA onto polypropylene in the presence of an initiator and a multi-functional acrylate comonomer. The multi-functional acrylate comonomer may comprise polyethylene glycol diacrylate, trimethylolpropane triacrylate (TMPTA), or combinations thereof.

The multi-functional acrylate comonomer may be further characterized by a high flash point. The flash point of a material is the lowest temperature at which it can form an ignitable mixture in air, as determined in accordance with ASTM D93. The higher the flash point, the less flammable the material, which is a beneficial attribute for melt reactive extrusion. In an embodiment, the multi-functional acrylate comonomer may have a flash point of from about 50° C. to about 120° C., or from about 70° C. to about 100° C. or from about 80° C. to 100° C. Examples of multi-functional acrylate comonomers suitable for use in this disclosure include without limitation SR259 (polyethylene glycol diacrylate), CD560 (alkoxylated hexanediol diacrylate), and SR351 (TAMA), which are commercially available from Sartomer.

In one or more embodiments, the reactive modifier may include from about 80 wt. % to about 99.5 wt. %, or from about 90 wt. % to about 99 wt. % or from about 95 wt. % to about 99 wt. % polyolefin based on the total weight of the reactive modifier, for example.

In one or more embodiments, the reactive modifier may include from about 0.5 wt. % to about 20 wt. %, or from about 1 wt. % to about 10 wt. % or from about 1 wt. % to about 5 wt. % grafting component (i.e., the epoxy functional group (e.g., GMA) and maleic anhydride functional group) based on the total weight of the reactive modifier, for example.

In one or more embodiments, the reactive modifier may exhibit a grafting yield of from about 0.2 wt. % to about 20 wt. %, or from about 0.5 wt. % to about 10 wt. % or from about 1 wt. % to about 5 wt. %, for example. The grafting yield may be determined by Fourier Transform Infrared Spectroscopy (FTIR) spectroscopy.

The polymeric materials containing biodegradable components may include from about 0.1 wt. % to about 20 wt. %, or from about 0.5 wt. % to about 10 wt. % or from about 1 wt. % to about 5 wt. % reactive modifier based on the total weight of the polymeric composition, for example.

In one or more embodiments, the polymeric materials containing biodegradable components may be prepared by contacting the polyolefin (PO), PLA or other polyester, and reactive modifier under conditions suitable for the formation of a polymeric blend. The blend may be compatibilized by reactive extrusion compounding of the PO, PLA, and reactive modifier. For example, polypropylene, PLA, and a reactive modifier (e.g., GMA) may be dry blended, fed into an extruder, and melted inside the extruder. The mixing may be carried out using a continuous mixer such as a mixer having an intermeshing co-rotating twin screw extruder for mixing and melting the components and a single screw extruder or gear pump for pumping.

Alternatively, such contact may include utilizing a multilayer film to form the polymeric materials containing biodegradable components. The multilayer film may be fabricated by coextruding a polyolefin layer, a PLA layer, and a tie layer comprising the reactive modifier, wherein the tie layer is disposed between the polyolefin layer and the PLA layer. Herein, the reactive modifier may function to compatibilize or chemically interlink the polyolefin layer and the PLA layer for improved cohesion.

In an embodiment, the polymeric materials containing biodegradable components may also contain additives to impart desired physical properties, such as printability, increased gloss, or a reduced blocking tendency. Examples of additives may include without limitation, stabilizers, ultra-violet screening agents, oxidants, anti-oxidants, anti-static agents, ultraviolet light absorbents, fire retardants, processing oils, mold release agents, coloring agents, pigments/dyes, fillers or combinations thereof, for example. These additives may be included in amounts effective to impart the desired properties.

### Product Application

While the polymeric materials containing biodegradable components may be used in forming different film or sheet-like materials having a generally small or reduced thickness, the polymeric materials containing biodegradable components have particular application to slit film tapes. Accordingly, the following description is with reference to such tapes. It should be apparent to those skilled in the art, however, that the invention is not limited to such tapes, but would apply to the same or similar materials where similar properties are desired. For example, the invention may be useful in preparing monofilament tapes.

Slit film tapes, also known as mono-axially oriented tapes, are defined as unidirectional oriented thermoplastic products with a high width-to-thickness ratio. Slit film tapes made of polyolefin's such as polypropylene (PP) and polyethylene (PE) and other similar polymeric materials are well known and have several applications. The major areas of application include woven sacks, large industrial sacks and packaging fabrics, geo-textiles, ropes and twines. miscellaneous industrial woven fabrics, and further processing, such as chopping into smaller pieces for addition to concrete to add structural reinforcement or improved fire resistance, for example.

Slit film tapes can he produced from extruded cast flat or tubular (blown) film, while blown film can be utilized for certain types of thin slit film tape yarns. The majority of slit film tapes are made from cast films, for example. Generally, the slit film tapes are formed by slitting of extruded film sheet which are then stretched by using one of the two known processes, stretching slit film together as a single bundle or individually in several group/bundles of strips, for example.

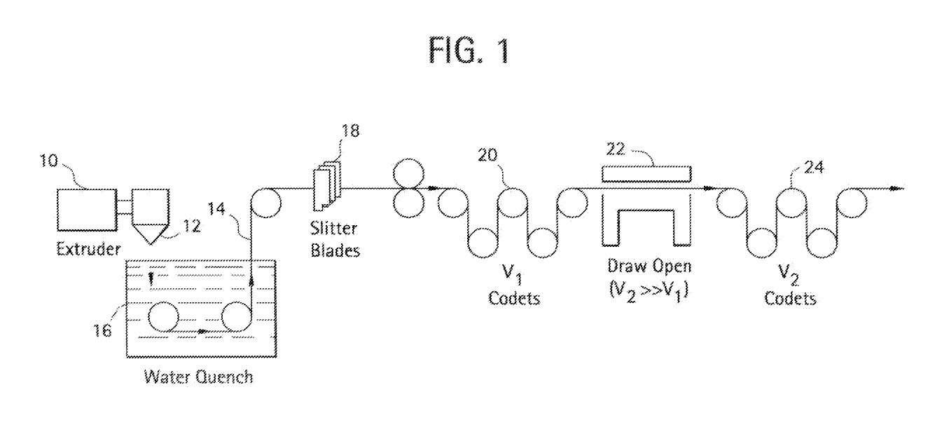

Referring to FIG. 1, which schematically illustrates one, non-limiting, example of a slit film line, the polymers (e.g., a biodegradable polymeric composition components of the present invention), as well as any additives, are melt blended within an extruder 10 and passed through a die 12 to form a layer of film 14. Alternatively, the polymers (e.g., blended biodegradable polymeric composition) may be formed into pellets for use at a later time. For slit film tape applications the film die may have a die opening of from about 10 to 30 mils to form a film of similar thickness. Upon extrusion through the die, the film may he quenched in a water bath 16 (e.g., at a temperature of from about 70 to 100° F.) or otherwise cooled, such as by the use of cooling rollers (not shown), for example.

After quenching, the film is slit longitudinally into one or more tape segments or slit film tapes. This may be accomplished through the use of a slitter 18 including of a plurality of blades spaced laterally apart at generally equal distances. The tapes may be slit into widths of from about 0.25 to about 2 inches, or from about 0.5 to about 1 inches, but such width may vary depending upon the application for which the tapes will be used.

The slit film tapes may then drawn or stretched in the longitudinal or machine direction (MD). This may be accomplished through the use of rollers or godets 20, 24 set at different rotational speeds to provide a desired draw ratio. A draw oven 22 for heating of the slit film tape to facilitate this drawing step may be provided. For slit film tapes draw ratios may be from about 3:1 to about 12:1, or from about 5:1 to about 7:1, for example. Drawing of the slit film tapes orients the polymer molecules and increases the tensile strength of the tapes. The final thickness of the drawn tapes may be from 0.5 mils to 5 mils, or from 1 to 3 mils, for example. The width of the drawn tapes may be from about 0.025 inches to about 0.70 inches, or from about 0.05 inches to about 0.4 inches, for example.

After the tapes are drawn, they may be annealed in an annealing oven or on annealing godets (not shown). Annealing reduces internal stresses caused by drawing or stretching of the tape. This annealing reduces tape shrinkage. The resulting machine-direction monoaxially-oriented tapes (MD monoaxially oriented tapes) may then be wound onto bobbins.

Tapes may be individually extruded as well in a direct extrusion process. In such a process, instead of slitting a plurality of tapes from a film, a plurality of individual tapes is extruded through multiple die openings.

In some embodiments of the invention, the monoaxially-oriented tapes produced from the polymeric materials containing biodegradable components in accordance with the present invention may exhibit improved drawability and other physical properties than those prepared from conventional synthetic polymeric materials. For example, those tapes prepared with the polymeric materials containing biodegradable components may exhibit a greater tenacity and better elongation than conventional monoaxially-oriented tapes prepared with neat polypropylene (polypropylene absent the PLA). Specifically, the polymeric materials containing biodegradable components may be stretched at lower forces than conventional synthetic polymeric materials.

The tapes of some embodiments of the invention also exhibit a unique matte or low gloss appearance in contrast to neat polypropylene, which appears shiny or glossy, thus the need for mechanical delustering may be eliminated. For example, the monoaxially-oriented tapes produced from the biodegradable compositions in accordance with the present invention may exhibit a significantly lower surface gloss that is reduced by at least about 30%, or at least about 40%, or from about 41% to about 75% as compared to the surface gloss of monoaxially-oriented tapes prepared from conventional synthetic polymeric materials (e.g., neat polypropylene) at the same draw ratio.

In some embodiments of the invention, the monoaxially-oriented tapes produced from the polymeric materials containing biodegradable components may exhibit a greater stillness as compared to the stiffness of monoaxially-oriented tapes prepared from conventional synthetic polymeric materials (e.g., neat polypropylene) at the same draw ratio. For example, tapes produced from compositions comprising a blend of neat polypropylene, PLA, and PP-g-GMA as the reactive modifier may exhibit greater stiffness as compared to the stiffness of tapes prepared from conventional synthetic polymeric materials (e.g., neat polypropylene) at the same draw ratio. As demonstrated in the Examples described below, monoaxially-oriented tapes produced from the biodegradable compositions in accordance with the present invention may exhibit a machine direction 1% secant modulus ˜50 kpsi greater than neat PP and PP/PLA blends produced at same conditions

### EXAMPLES

The following examples are for illustration purposes only, and are not intended to he limiting.

### Example 1

Five polypropylene-based samples were prepared. The first sample was a semi-crystalline propylene homopolymer commercially available as neat Total Petrochemicals 3271 (“neat 3271”), referred to herein as the reference sample. The second sample was a blend of neat 3271 PP and PLA 6201D (PP/PLA), wherein the concentration of PLA was about 10 wt. % based on the total weight of the blend. The third, fourth and fifth samples were blends prepared by melt blending the reactive modifier additives glycidyl methacrylate grafted polypropylene (PP-g-GMA), polyethylene-glycidyl methacrylate random copolymer (PE-co-GMA), and maleic anhydride grafted polypropylene PP-g-MA, respectively, with neat 3271 PP and 10 wt. % PLA, wherein the concentration of the reactive modifier in each of these samples was about 5 wt % based on the total weight of the blend. The blends were compounded on a 27 mm twin screw extruder and then pelletized. The pellets were further cast into 16 mil-thick sheets on a 1.25″ single screw extruder equipped with a film die. The sheets were aged at atmospheric condition for at least 48 hrs prior to mono-orientation evaluation

TABLE 1
PP/PLA blend compositions for mono-axially oriented films

| Samples | Description | Compositions |
|---|---|---|
| 1 | PP | Neat Total Petrochemicals 3271 |
| 2 | PP/PLA | 90% 3271 + 10% PLA 6201D |
| 3 | PP/PP-g-GMA/PLA | 85% 3271 + 5% PP-g-GMA + |
| | | 10% PLA 6201D |
| 4 | PP/PE-co-GMA/PLA | 85% 3271 + 5% Lotader AX8840 + |
| | | 10% PLA 6201D |
| 5 | PP/PP-g-MA/PLA | 85% 3271 + 5% Polybond 3002 + |
| | | 10% PLA 6201D |

### Example 2

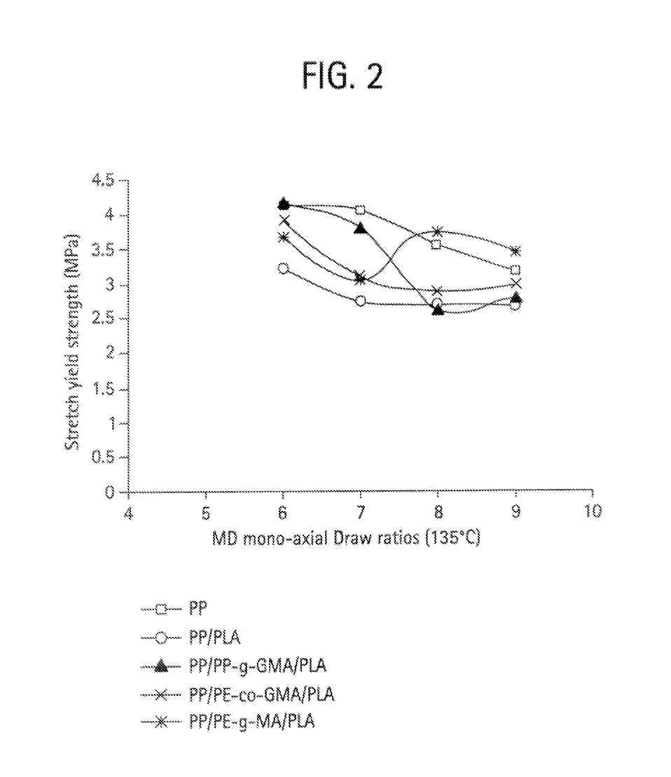

The samples in Example 1 were monoaxially oriented using a Brückner Karo IV stretching machine. To evaluate the solid-state drawability of the samples, films of each sample were stretched to machine direction (MD) monoaxial draw ratios of 6:1, 7:1, 8:1 and 9:1 at a temperature of either 135° C. or 150° C. with a pre-heat time of 30 seconds. To mimic conventional slit tape processing, all films were stretched at a speed of 30 m/min. FIG. 2 shows the Bruckner stretch yield strengths for the sheet samples stretched at temperature of 135° C. Even though the stretch forces varied for the same samples at different draw ratios, generally, the samples comprising PLA require less force to stretch, which indicates better drawability during slit tape production, as compared to the PP reference sample (first sample).

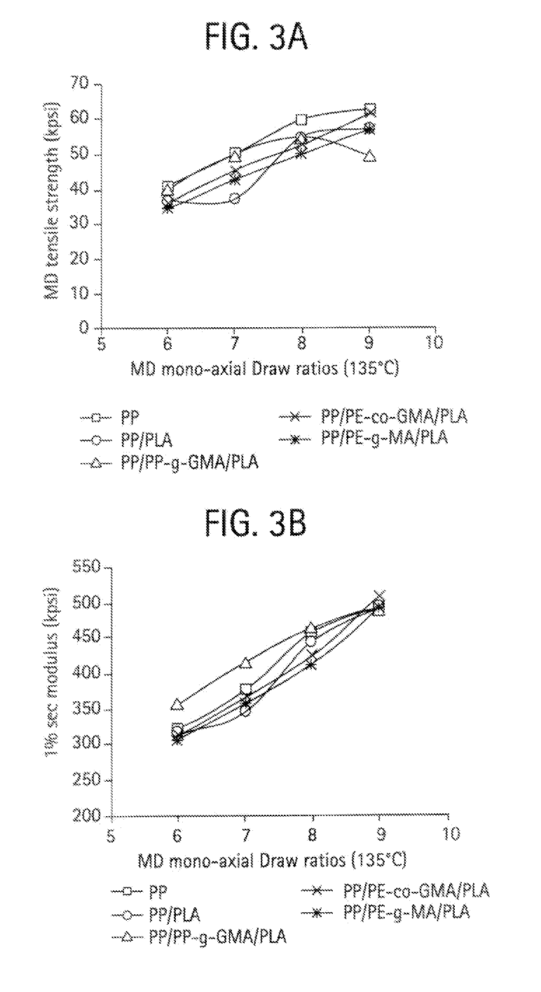

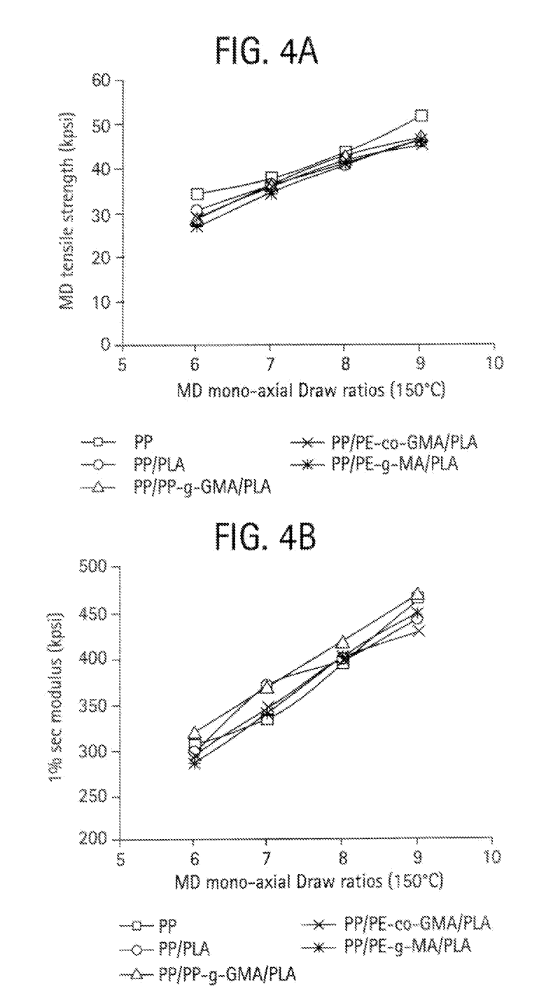

The resulting MD monoaxially oriented film samples stretched at. 135° C. and 150° C. were characterized for tensile strength and stiffness in the machine direction of the films. Tensile strength measurements were made in accordance with ASTM D638. FIGS. 3A and 3B show the MD tensile strength at yield and MD 1% secant modulus as a function of draw ratio, respectively, for each of the films stretched at 135° C. Likewise, FIGS. 4A and 4B show the MD tensile strength at yield and MD 1% secant modulus as a function of draw ratio, respectively, for each of the films stretched at 150° C. Upon inspection of FIG. 3A, the films comprising PLA exhibit comparable tensile strengths as compared to the tensile strengths of the PP reference film sample, while demonstrating about the same or higher stiffness as illustrated in FIG. 3B. Most notably, the films comprising PLA and reactive modifier PP-g-GMA demonstrate similar tensile strengths at draw ratios of 6:1 or 7:1, while exhibiting significantly higher stiffness as compared to the PP reference film. Similarly, FIG. 4A also demonstrates that the films comprising PLA exhibit comparable tensile strengths as the PP reference film, while demonstrating about the same or higher stillness at draw ratios of 6:1, 7:1, and 8:1 as illustrated in FIG. 4B. The stiffness data of the monoaxially oriented films produced from PP-based blends containing PLA are particularly interesting in light of the fact that PLA has a much higher Young's modulus as compared to PP. In summary, monoaxially oriented films produced from PP/PLA blends may exhibit comparable MD tensile strength and equivalent stiffness than monoaxially oriented PP films. Also, monoaxially oriented films produced from PP/PLA blends comprising reactive modifier PP-g-GMA may possess even higher stiffness as compared to monoaxially oriented PP films.

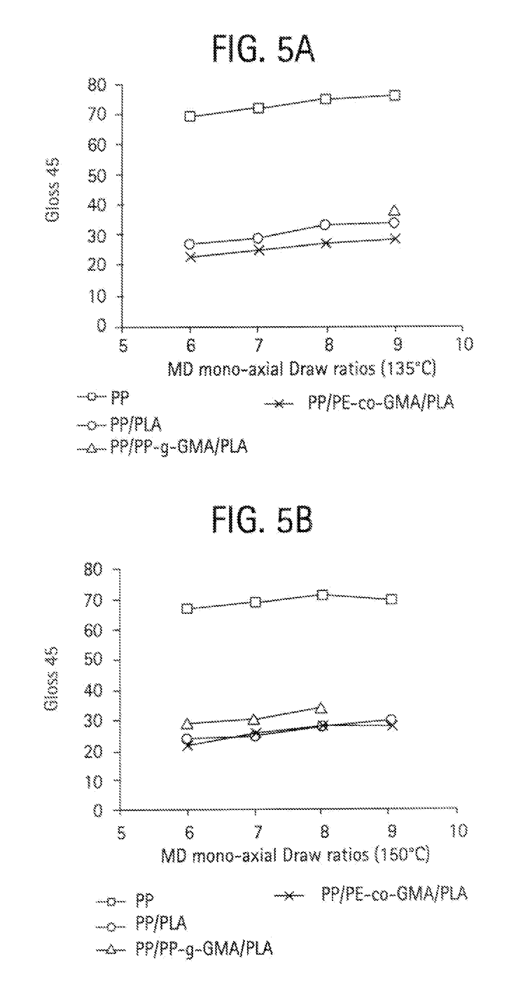

The surface gloss of the resulting MD monoaxially oriented film samples stretched at temperatures 135° C. and 150° C. were measured as a function of draw ratio and plotted in FIGS. 5A and 5B, respectively. Surface gloss measurements at an angle of 45 degrees were made in accordance with ASTM D2457. FIGS. 5A and 5B show the monoaxially oriented PP films appeared very glossy, whereas the films formed from blends having PLA exhibit significantly lower surface gloss at values less than about 40, or from about 20 to about 40. The decrease in gloss of the monoaxially oriented films comprising PLA is greater than 50% as compared to the monoaxially oriented PP reference film at each draw ratio. As a result, slit tapes made from PP/PLA blends can exhibit substantially lower surface gloss and thus may eliminate the need of a delustering processing step conventionally utilized to produce low gloss slit tapes. Eliminating the delustering step is particularly advantageous not only to reduce the number of processing steps, but also because the conventional delustering process typically employs sand paper-plated rolls that undesirably generate dust hazards to operators and present a safety concern to slit tape producers. Thus, reformulation of polyolefin-based tapes with a small amount of PLA can result in a dramatically lower gloss slit tape, thereby eliminating a need for mechanical delustering.

### Example 3

In another example, biodegradable multilayer films having a PP layer, a PLA layer and a tie layer comprising one of the reactive modifier additives were formed and monoaxially stretched in order to evaluate the tensile strength and stiffness of MD monoaxially oriented multilayer films comprising PLA as a coextruded layer for slit film tape applications. For comparison purposes, the first sample is a 16 mil thickness film of semi-crystalline propylene homopolymer commercially available as neat Total Petrochemicals 3371 (“neat 3371”), referred to herein as the reference film sample. The second sample is a multilayer film formed by coextruding a PP layer made of neat 3371 PP, a PLA layer made of PLA 6201D, and a tie layer made of PP-g-GMA disposed between the PP and PLA layers so as to form a multilayer sheet of PP-PP-g-GMA-PLA. The third sample is a multilayer film formed by coextruding a PP layer made of neat 3371 PP, a PLA layer made of PLA 62011), and a tie layer made of PF-co-GMA disposed between the PP and PLA layers so as to form a multilayer sheet of PP-PE-co-GMA-PLA. The second and third multilayer sheet samples were also formed to a total thickness of 16 mils.

TABLE 2
PP/PLA co-extrusion compositions for mono-axially oriented films

| Samples | Description | Compositions |
|---|---|---|
| 6 | PP sheet | 16 mil thick Neat Total Petrochemicals |
| | | 3371 |
| 7 | PP--PP-g-GMA--PLA | 14 mil 3371 + 0.5 mil PP-g-GMA + |
| | co-ex sheet | 1.5 mil PLA 3201D |
| 8 | PP--PE-co-GMA-- | 14 mil 3371 + 0.5 mil PP-co-GMA + |
| | PLA co-ex sheet | 1.5 mil PLA 6201D |

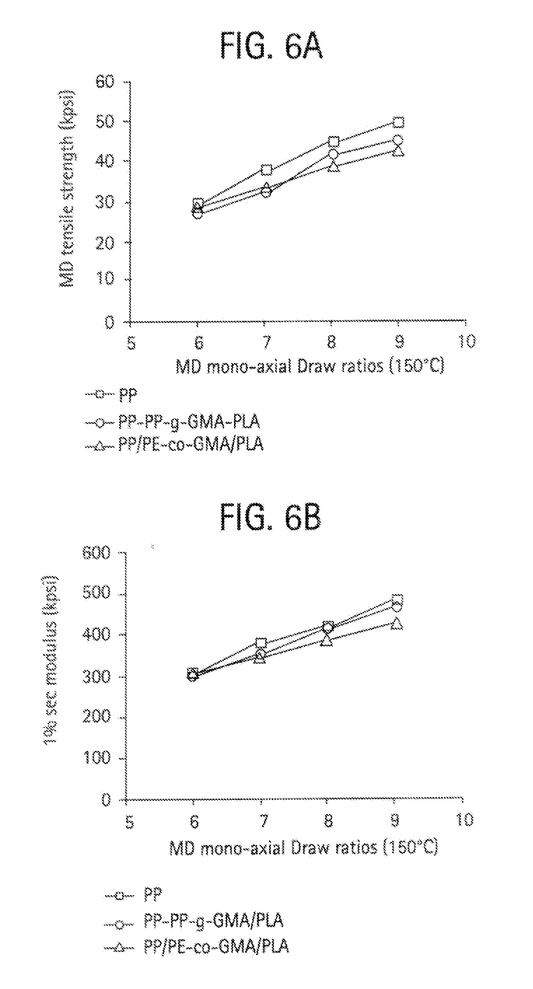

Subsequently, the first, second and third samples were monoaxially oriented using a Bruckner Karo IV stretching machine. Each sample was stretched to machine direction (MD) monoaxial draw ratios of 6:1, 7:1, 8:1 and 9:1 at a temperature of 150° C. To mimic conventional slit tape processing, all films were stretched at a speed of 30 m/min. The resulting MD monoaxially oriented film samples were characterized for tensile strength and stiffness in the machine direction of the films. Tensile strength measurements were made in accordance with ASTM D638. FIGS. 6A and 6B show the MD tensile strength at yield and MD 1% secant modulus as a function of draw ratio, respectively, for each of the films. Upon inspection of FIG. 6A it is apparent that the monoaxially oriented coextruded film samples exhibit comparable tensile strengths as compared to the tensile strengths of the PP reference film. FIG. 6B illustrates that the monoaxially oriented coextruded film samples exhibit comparable stiffness as compared to the stiffness of the PP reference film, however no significant improvement in stiffness is apparent in these coextruded film samples (as was previously demonstrated by the monoaxially-oriented blended film samples discussed in the previous Example). Even though no gains were obtained in mechanical properties, the mono-axially oriented films with PLA caps may find applications where higher surface tension was deemed necessary.

### Example 4

Five PP/PLA samples were prepared for slit tape processing and property evaluations. The first sample was a high crystallinity propylene homopolymer commercially available as neat Total Petrochemicals 3270, referred to herein as the reference sample. The second sample was a blend of 3270 PP and PLA 3251 (PP/10%/PLA), wherein the concentration of PLA was about 10 wt. % based on the total weight of the blend. The third, fourth and fifth samples were blends prepared by melt blending 3% reactive modifier additives polyethylene-glycidyl methacrylate random copolymer (PE-co-GMA), ethylene-methyl acrylate copolymer (EMAC 2207, Westlake) and glycidyl methacrylate grafted polypropylene (PP-g-GMA), respectively, with neat 3270 PP and 10 wt. % PLA3251, wherein the concentration of the reactive modifier in each of these samples was about 3wt % based on the total weight of the blend. The blends were compounded on a 27 mm twin screw extruder and then pelletized.

TABLE 3
PP/PLA blend compositions for slit tape evaluations

| Samples | Description | Compositions |
|---|---|---|
| 9 | 3270 | 100% 3270 |
| 10 | 3270/10% PLA | 90% 3270 + 10% PLA 3251 |
| 11 | 3270/3% PE-co-GMA/10% | 87% 3270 + 3% PE-co-GMA + |
| | PLA | 10% PLA 3251 |
| 12 | 3270/3% EMA/10% PLA | 87% 3270 + 3% EMAC 2270 + |
| | | 10% PLA 3251 |
| 13 | 3270/3% PP-g-GMA/10% | 87% 3270 + 3% PP-g-GMA + |
| | PLA | 10% PLA 3251 |

The materials were cast into 6 mil thick films first on a 1.5′ single screw extruder. The melt temperature was set at less than 390° F. to minimize PLA degradation. Then the films were fed into the Bouligny slit tape line at a rate of 20 feet per minute. After that, the film was slit longitudinally into ˜0.25 inches wide tape segments or slit film tapes through the use of a plurality of blades spaced laterally apart at generally equal distances. The slit film tapes were then drawn or stretched up to different draw ratios in the longitudinal or machine direction (MD) inside an oven set at 320° F. When drawing was completed, the tapes were annealed at 250° F. at a 3% relaxation rate before collecting samples. For neat 3270, when draw ratio was 12 and up, stress whitening was obtained. With addition of PLA and or compatibilizers, stress stress whitening disappeared, indicative of improved slit tape defibrillation.

While the foregoing is directed to embodiments of the present invention, other and further embodiments of the invention may be devised without departing from the basic scope thereof and the scope thereof is determined by the claims that follow.

What is claimed is:

1. A process of forming a monoaxially-oriented film comprising:
providing a propylene-based polymer;
contacting the propylene-based polymer with polylactic acid in the presence of a modifier to form a polymeric blend, wherein the modifier is selected from epoxy-functionalized polyolefins, maleic anhydride modified polyolefins, ethylene-methacrylate copolymers, styrene-ethylene-butadiene-styrene (SEBS) Polymers, and combinations thereof;
forming the polymeric blend into a film; and
monoaxially orienting the film.

2. The process of claim 1, wherein the propylene-based polymer is selected from polypropylene homopolymer, polypropylene based random copolymer, and polypropylene impact copolymer.

3. The process of claim 1, wherein the contact comprises melt blending the propylene-based polymer, the polylactic acid, and the modifier.

4. The process of claim 1, wherein the polylactic acid has a concentration of from about 0.1 wt. % to about 49 wt. % based on the weight of the polymeric blend.

5. The process of claim 1, wherein the modifier has a concentration of from about 0.0 wt. % to about 20 wt. % based on the weight of the polymeric blend.

6. The process of claim 1, wherein the modifier is glycidyl methacrylate grafted polypropylene.

7. The process of claim 1, wherein the modifier is polyethylene co-glycidyl methacrylate.

8. The process of claim 1, wherein the modifier is maleic anhydride grafted polypropylene.

9. The process of claim 1, wherein the modifier is ethylene-methyl acrylate copolymer.

10. The process of claim 1, wherein the modifier is styrene-ethylene-butadiene-styrene (SEBS) polymers.

11. The process of claim 1, wherein the monoaxially oriented film has a machine direction 1% secant modulus greater than about 250 kpsi.

12. The process of claim 1, wherein the monoaxially Oriented film has a machine direction 1% secant modulus in a range from about 300 kpsi to about 500 kpsi.

13. The process of claim 1, wherein the monoaxially oriented film has a machine direction tensile strength at yield of greater than about 25 kpsi.

14. The process of claim 1, wherein the monoaxially oriented film has a machine direction tensile strength at yield in a range from about 30 kpsi to about 60 kpsi.

15. The process of claim 1, wherein the monoaxially oriented film has a gloss 45° of less than about 100.

16. A film comprising a melt blended mixture of a propylene-based polymer, a polylactic acid, and a modifier, wherein the modifier is selected from epoxy-functionalized polyolefins, maleic anhydride modified polyolefins, ethylene-methacrylate copolymers, styrene-ethylene-butadiene-styrene (SEBS) polymers, and combinations thereof.

17. The film of claim 16, wherein the propylene-based polymer is selected from polypropylene homopolymer, polypropylene based random copolymer, and polypropylene impact copolymer.

18. The film of claim 16, wherein the modifier is selected from glycidyl methacrylate grafted polypropylene, polyethylene co-glycidyl methacrylate, maleic anhydride grafted polypropylene, styrene-ethylene-butadiene-styrene (SEBS) polymers, and combinations thereof.

19. The film of claim 16, wherein the polylactic acid has a concentration of from about 0.1 wt. % to about 49 wt. % based on the weight of the melt blended mixture.

20. The film of claim 16, wherein the modifier has a concentration of from about 0.0 wt. % to about 20 wt. % based on the weight of the melt blended mixture.

21. The film of claim 16, wherein the film has a gloss 45° of less than about 100.
